(19) United States
(12) Patent Application Publication
(10) Pub. No.: US 2007/0124211 A1
(43) Pub. Date: May 31, 2007

(54) Methods and apparatus for wireless point-of-sale transactions

(76) Inventor: Steven B. Smith, Draper, UT (US)

Correspondence Address: KIRTON AND MCCONKIE, 60 EAST SOUTH TEMPLE,, SUITE 1800, SALT LAKE CITY, UT, 84111, US

(21) Appl. No.: 11/440,827

(22) Filed: May 25, 2006

Related U.S. Application Data
(62) Division of application No. 09/536,273, filed on Mar. 27, 2000.

(51) Int. Cl. G06Q 20/00

(52) U.S. Cl. 705/21

(57) ABSTRACT

The present invention relates to systems, methods and apparatus for making purchase transactions at a point-of-sale. A wireless purchase device (WPD) comprising a short range communications device for communication with vendor point-of-sale equipment such as a wireless vendor device (WVD) and a long range communications device for communications with credit or debit authorization processors. In preferred embodiments, a WVD will communicate vendor identification data and a transaction purchase price to a WPD and a WPD user will determine whether to complete the transaction. The transaction may be completed by transmitting the vendor identification and purchase data to an authorization processor for credit or debit approval. Authorization approval or denial is transmitted to the WPD where the user is discretely notified of the outcome. If approved, the user may transmit the approval to the WVD to complete the transaction. Using the systems and methods of the present invention, vendors need not maintain long range communications between points-of-sale and authorization processors or other parties. Purchasers also benefit from the discrete notification of credit or debit approval or rejection.

### THE FIELD OF THE INVENTION

The present invention relates to methods and apparatus for point-of-sale transactions using wireless communication devices. Embodiments of the present invention utilize wireless purchasing devices (WPDs) to communicate with point-of-sale wireless vendor devices (WVDs) and arrange the electronic transfer of assets to complete a sale. WPDs of embodiments of the present invention may negotiate a purchase code with a WVD and obtain authorization to complete a purchase identified in the purchase code directly from a creditor or account holder. When authorization is approved, an authorization code is transmitted from the creditor/account holder directly to the WPD and a purchase authorization code is transmitted to the WVD to complete the transaction. Embodiments of the present invention may be used with human-operated vendor devices such as electronic cash registers or with automated vendor devices such as electronic vending machines.

### BACKGROUND

Electronic transactions involving the transfer of money and pecuniary assets are common in our society today. Stocks and bonds may be purchased and traded using only electronic transactions. Goods and services are also commonly purchased over the telephone or via the Internet using credit or debit accounts with electronic authorization.

Retail vendors typically accept credit and debit cards which are verified and authorized using electronic communications methods. Nearly every significant retail vendor accepts some form of credit or debit card as remuneration for goods or services. The accounts accessed through these cards are typically identified by a number embossed on the card and a magnetic strip on the card's surface that is encoded with account information. Transactions involving a credit or debit card account require authorization from the organization who issues the card. This authorization is generally obtained at the point-of-sale by a vendor through electronic communications channels. A transaction amount is determined and the amount of the transaction along with the account identification information are transmitted to the organization which issued the card. If the account has sufficient credit or funds to cover the transaction amount and the account has not been deactivated for some other reason, the card issuer will send an authorization code to the vendor which indicates that the issuer will transfer the authorized amount to the vendor at an appropriate time.

Account information may be obtained by swiping the electronic strip of the card across a magnetic reader thereby eliminating the need for manual input. The transaction amount may also be transferred from an electronic cash register and combined with the account information automatically to make an authorization request.

These point-of-sale authorization request devices are typically connected to the card issuers or their representatives, sometimes known as authorization processors, through a conventional telephone line. Often a dedicated phone line is connected to the point-of-sale authorization device for quick access to authorization data.

These point-of-sale devices may also be connected via wireless telecommunications connections, generally with cell phone or cell modem technology. This wireless connection allows the point-of-sale device to be more portable, but still requires a dedicated or available communications link to the authorization processor.

Known authorization request systems and methods all employ a communications link between the vendor and authorization processor whether the link be a land line or a wireless link. These systems require the vendor to maintain a communications link for each sales terminal. For conventional, wired systems this may amount to multiple dedicated phone lines often with long-distance connection charges. For wireless systems, an expensive cell-phone-based account or other wireless provider account is required. These connections can be expensive to maintain and can cripple a vendor when service is interrupted.

A full-time communication link can also be impractical or uneconomical for low volume vendors who do not have sufficient profit to justify the connection costs. Vending points in remote locations may not justify the cost of a wireless connection.

With known systems and methods, each vendor must maintain a proprietary communications link between the vending point and the authorization processor. When multiple vendors occupy a single location, multiple communications links must be maintained thereby increasing energy demands and monopolizing available communications bandwidth.

The costs of vendor communication links add to vendor overhead which must be accounted for by increasing revenue, typically through increased product prices. Therefore, the consumer eventually pays the price for this communication and any associated inefficiency.

Wireless communication technology has progressed rapidly in recent years. Cell phones and other long-range communication devices have proliferated and are now commonplace among consumers. As technology advances, the cost of these devices is plummeting and even more widespread use is eminent. Mobile phones, pagers, two-way radios, smartphones, personal digital assistants (PDAs) and other communicators are all available on the market.

Internet use is also skyrocketing with millions of new users logging on each year. Internet commerce now represents a significant portion of retail commerce and is used by millions of consumers each day.

Communications protocols exist which allow present generation electronic communications devices to interface with the Internet and access Internet resources. The Wireless Application Protocol (WAP) is an open, global specification that enables mobile wireless communications devices to access and interact with Internet information and services. WAP is a communications protocol and environment which can be built on nearly any operating system including PalmOS, EPOC, Windows CE, FLEXOS, OS/9, JavaOS and others and provides service interoperability between different device families. WAP works with most existing wireless communications networks such as CDPD, CDMA, GSM, PDC, PHS, TDMA, FLEX, ReFLEX, iDEN, TETRA, DECT, DataTAC, Mobitex and others. WAP developers operate Internet gateways specifically tailored for wireless communications device users. These devices typically have small displays, limited memory and less bandwidth that stationary, wire connected computers, therefore, WAP provides for use of eXtended Markup Languages (XMLs) such as the Wireless Markup Language (WML) which offers Internet content tailored for cell phones, PDAs and other wireless, portable communications devices.

Using WAP and similar technologies, vendors, news agencies, financial institutions and other providers allow cell phone and other portable communications device users to buy and sell securities, execute credit card transactions, make account transfers, make bill payments, receive and send e-mail, view news reports. These providers offer seamless integration between the Internet and wireless portable communication devices.

Wireless communication devices are also becoming commonplace in the electronics industry. Wireless networking of portable computers and associated devices is now replacing a large segment of the networking market. Wireless communication devices including wireless networking adapters, hubs and other equipment utilize radio transmitters and receivers to transmit data signals from one device or node to another. These radio transmitters and receivers must utilize a specific frequency band and protocol to accomplish this task. Since these wireless networks and communications areas may often overlap, standards, protocols and privacy protection are necessary. One current standard in the industry has been established by the Institute of Electrical and Electronics Engineers, Inc. (IEEE) and is known as IEEE 802.11. This standard comprises communications standards, protocol and equipment specifications for wireless communication equipment including privacy and encryption provisions.

Another innovation in the wireless communications arena is the advent of short-range wireless networking between portable communications devices. One standard for this technology is known as Bluetooth®, and is being established by a collaborative group of communications and computing companies. Devices incorporating Bluetooth® technology will utilize a micro-chip transceiver for communications between devices. Bluetooth® devices will transmit in the previously unused 2.4 GHz range and will have a range of about meters which may be extended to about 100 meters by increasing transmitter power. Bluetooth® technology promises to be a viable and economical networking solution for interconnection of cell phones, computers, printers, modems, computer peripherals, fax machines and other communications and computing devices. The size of the Bluetooth® transceiver makes it usable in devices as small as palm computers and cell phones.

Another established wireless connectivity standard is known as IrDA and employs infrared radiation to communicate between devices. IrDA is a point-to-point narrow angle, ad-hoc data transmission standard designed t operate over a distance of 0 to 1 meter at speeds of 9600 bps to 16 Mbps. It is typically used in a point-and-shoot fashion by pointing one device at another for direct data transmission.

The combination of some of the above technologies allows a user to use a single electronic device to communicate with other electronic devices in a short range network or direct data link while establishing a long-range communications connection with mobile phone or other technology.

### SUMMARY AND OBJECTS OF THE INVENTION

Preferred embodiments of the present invention provide systems, methods and apparatus which provide for short range communication with a point-of-sale device combined with long-range communication with a credit or debit authorization processor. As a non-limiting example, an embodiment of the present invention in the form of a PDA may communicate with a point-of-sale device to determine vendor identification and a sale amount. The vendor/sale data is combined with credit or debit account data and forwarded to an authorization processor as a request for authorization of the sale amount. The authorization processor processes the request and transmits an authorization approval or denial to the PDA through a long range communication system. The authorization is then transmitted to the vendor's point-of-sale device to complete the transaction.

Embodiments of the present invention allow for transactions with multiple vendors. A consumer with a wireless purchasing device (WPD) may enter an area in which several vendors have point-of-sale devices which can communicate with the WPD. As the consumer enters communication range with the point-of-sale devices, a menu on the WPD is updated to reflect the products available from vendors in communication range along with associated prices and related data. A consumer may select from the available products and initiate the purchase. Vendor information, product identification and pricing data received from the point-of-sale devices is processed into purchase requests for each vendor selected and the purchase requests are transmitted to one or more authorization processors. If the purchases are authorized, the authorization approval is transmitted back to the WPD and the consumer completes the transaction by transmitting a charge or debit authorization to the point-of-sale devices thereby enabling product access or delivery of the purchased products.

Accordingly it is an object of some embodiments of the present invention to provide systems, method and apparatus for obtaining a point-of-sale purchase authorization.

It is another object of some embodiments of the present invention to provide systems methods and apparatus for obtaining a point-of-sale purchase authorization for a purchase from a vendor who does not have a communications link with an authorization processor.

### BRIEF DESCRIPTION OF THE DRAWINGS

In order that the manner in which the above-recited and other advantages and objects of the invention are obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a diagram showing components of a preferred embodiment of the present invention;

FIG. 2 is a diagram illustrating the typical use of an embodiment of the present invention with a single WVD; and

FIG. 3 is a diagram illustrating the typical use of an embodiment of the present invention with multiple WVDs.

### DETAILED DESCRIPTION OF THE PREFERRED EMBODIMENTS

The present invention may be embodied in other specific forms without departing from its spirit or essential characteristics. The described embodiments are to be considered in all respects only as illustrated and not restrictive. The scope of the invention is, therefore, indicated by the appended claims rather than by the foregoing description. All changes which come within the meaning and range of equivalency of the claims are to be embraced within their scope.

Preferred embodiments of the present invention comprise a portable electronic communications device which is capable of communicating with a vendor's point-of-sale device and capable of communicating with an independent financial institution such as a bank or credit lender. In many embodiments, these two communication functions will be achieved using two communications protocols or methods. One method will employ a short range communication or networking device to communicate with a vendor's point-of-sale device. The other method will use a long range wireless communication system to contact financial institutions for payment authorization and execution.

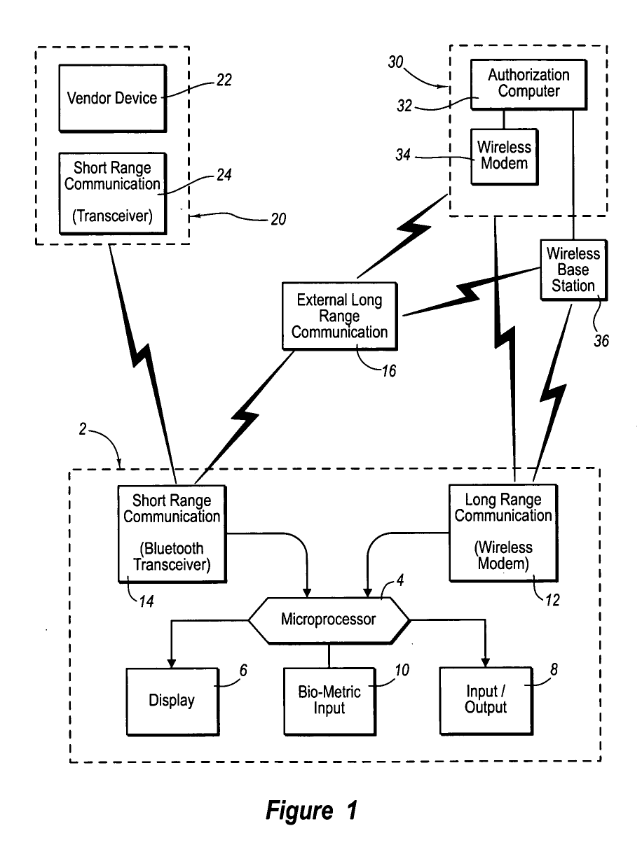

In reference to FIG. 1, a preferred embodiment of a consumer's wireless purchasing device (WPD) 2 is shown comprising a microprocessor 4 for processing consumer input, communications functions and display functions as well as other functions. WPD 2 may also comprise a display 6 in preferred embodiments, however display 6 is not required for rudimentary embodiments. An input device 8 may also be part of WPD 2 to allow for consumer input and selection. WPD 2 may communicate with other electronic devices using a short-range communications device 14. Short range communications device 14 may be used to communicate with a vendor's point-of-sale device, such as wireless vending device (WVD) 20, with other WPDs, with external communication device or with other electronic devices. However, the key function of short range communications device 14 is to communicate with WVDs, and in some embodiments with external long range communication device 16. Short range communications device 14 may be a Bluetooth® transceiver or similar short range networking device or may be an Infrared transceiver such as an IrDA standard port as well as other devices.

Some embodiments of the WPD of the present invention will also comprise a long range communications device 12 for communication with an authorization provider 30. Long range communications device 12 may take the form of a cell modem, radio modem or other wireless communications device capable of transmitting and receiving data over a large area.

When a consumer already has possession of a cell phone or other long range communications device 16 which also has short range communications ability, such as a Bluetooth® enable cell phone, the consumer may prefer to use a less-expensive embodiment of the WPD which uses short range communications device 14 to interact with the external long range communications device 16 for contact with authorization provider 30.

Some embodiments of the WPD of the present invention may also comprise a biometric input device 10 to verify user identity. Biometric input device 10 may use thumb print analysis, retinal scan analysis or another identification method to identify the WPS user. Once the user is identified, user identity can be matched to account data to ensure that unauthorized users do not gain access to sensitive information or other user's accounts.

Embodiments of the present invention also comprise a wireless vendor device (WVD) 20 which is typically positioned at a point-of-sale for communication with WPDs. WVD 20 will generally comprise a short range communications device 24 configured to communicate with short range communications device 14 used in WPDs. As with communications device 14, device 24 may be a Bluetooth® transceiver, an IrDA port or another communications device. In situations where multiple vendors are accessible to a single WPD at the same time, a Bluetooth® transceiver or similar networking device is preferred to allow multiple party communications. Short range communications device 24 is connected to a vendor device 22 which is typically an electronic computing device such as an electronic cash register, an electronic vending machine, a bar-code reader or other device which may transmit and receive product and transaction information.

As embodiments of the present invention are to be used with credit and debit card accounts which generally require authorization before funds may be transferred, WPDs may communicate with authorization providers 30 using long range communication device 12 or 16. WPD communication device 12 or 16 may communicate with authorization long range communications device 34 using known wireless communications methods such as through the use of wireless modems. This communication may be direct between communication device 12 or 16 and 34 or may involve a wireless communications base 36 which receives and transmits wireless signals and converts them to a wired connections such as with a standard telephone line. Authorization communications device 34 provides access to authorization computer 32 which may authorize credit and debit transactions and execute transfers of funds to the appropriate accounts.

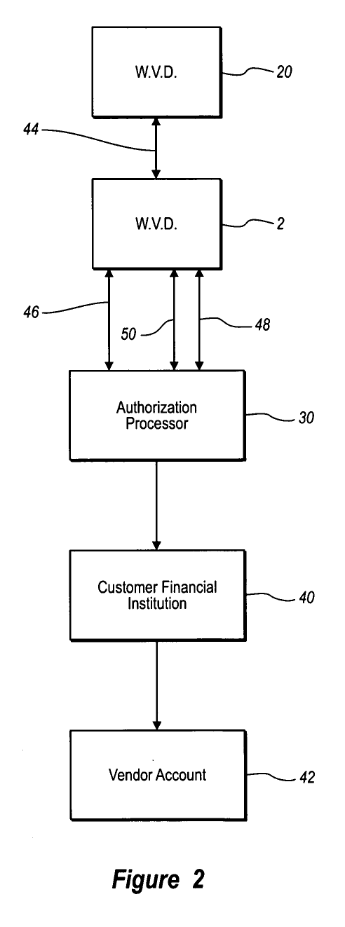

A variety of communication protocols and methods are known and commonly used in the industry, therefore, the information transfer used in some embodiments of the present invention is shown in a generic format in FIG. 2. Typically a purchase transaction will commence by establishing communication between a WPD 2 and a WVD 20. WPD may receive product or service information from WVD which may be presented on the display 6 of WPD 2. In some embodiments, a consumer may then make a selection between menu items presented on display 6 or otherwise indicate a desire to make a purchase. In some situations, a WVD may simply transmit a transaction amount and vendor identification to the WPD, such as when a cashier has tallied a total and seeks payment or when an automated vending machine offers a single selection. In most situations, the WVD 20 and WPD 2 will communicate 44 with or without vendor and consumer input until a total purchase amount is reached. When a transaction amount is established, the WPD 2 will use its long range communications ability to contact an authorization provider 30 to request authorization 46 of the credit or debit transaction. Authorization processor 30 will check the consumer's account to verify that sufficient funds or credit are available and make any other necessary verification as required. If authorization is denied, a denial 48 will be transmitted to the WPD 2 and the consumer will be notified on the WPD display 6 that the transaction cannot be completed. If the authorization is approved, an authorization approval 50 will be transmitted to the WPD 2 which will use its short range communications link to pass the authorization to the WVD to inform the vendor of the transaction so that the goods or services may be released.

Authorization by authorization processor 30 also causes a request to be transmitted from processor 30 to the customer's financial institution 40 to transfer funds from the customer's account to the vendor's account 42.

In this manner, the transaction may be completed without any direct communication between a vendor and an authorization processor or financial institution. This method allows a vendor to operate a WVD at a point-of-sale without the expense and inconvenience or a long range communication connection. This method also allows the consumer to retain confidential account information without disclosure to vendor personnel or exposure to the risks present in the vendor's system.

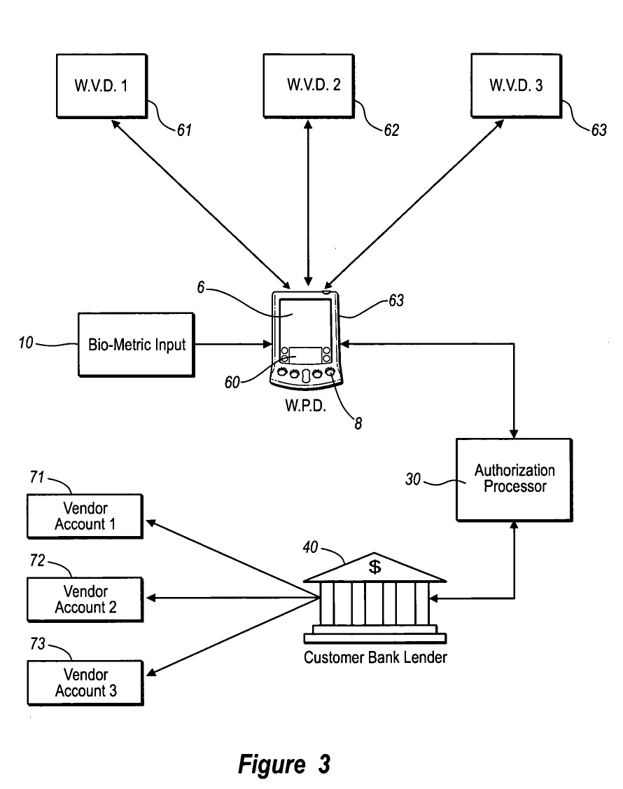

In reference to FIG. 3, embodiments of the present invention which accommodate multiple, simultaneous vendors are illustrated. In these embodiments WvDs and WPDs will generally utilize wireless networking technology such as Bluetooth® transceivers or others to communicate. WVD1 61, WVD2 62 and WVD3 63 are present within communication range of a single WPD 2 and communication between WVDs 61, 62 and 63 and WPD 2 is initiated upon communication contact. In a preferred embodiment WVDs 61, 62 and 63 will transmit menu options to WPD 2 to inform the consumer of available products and to identify the vendors associated with the WVDs. WVDs 61, 62 and 63 may be electronic vending machines or other vendor devices. A consumer may view the menu 60 on the WPD display 6 to see the available products and make selections with WPD input device 8. When a final selection is made by the consumer, the WPD 2 will request authorization for the purchase by contacting authorization provider 30. Authorization provider 30 may request user identification before approval. Identification may be provided through the use of a confidential PIN number or for increased security may be provided by biometric identification device 10. When identification is verified, authorization provider 30 will check account status and approve or deny the transaction according to internal rules. If approval is granted, an authorization approval is transmitted to WPD 2 and a transfer of funds request is transmitted to the consumer's financial institution 40 who will transfer appropriate amounts of funds to the accounts 71, 72 and 73of vendors who were selected in the consumers menu selection on the WPD 2.

When the WPD 2 receives the authorization approval, the approval is displayed to the consumer on display 6 (in embodiments with displays) and a transaction finalization command is transmitted from WPD 2 to WVDs 61, 62 and 63 to instruct WVDs to release the purchased products, provide the purchased services or otherwise credit the consumer for the purchase.

I claim:

1-24. (canceled)

25. An apparatus carried by a purchaser in performing wireless point-of-sale purchase transactions comprising:
a microprocessor;
a short range communications device electrically coupled to the microprocessor for automatically receiving sales information from and forwarding authorization information to a point-of-sale wireless vendor device for communicating with a point-of-sale wireless vendor device;
a long range communications device electrically coupled to the microprocessor for communicating without vendor participation a request to an authorization processor and receiving a response from the authorization processor for authorization of a purchase; and
an input device electrically coupled to the microprocessor.

26. The apparatus of claim 25, further comprising a display electrically coupled to the microprocessor.

27. The apparatus of claim 25, further comprising a bio-metric input device electrically coupled to the microprocessor.
